(19) United States
(12) Patent Application Publication
(10) Pub. No.: US 2013/0346147 A1
(43) Pub. Date: Dec. 26, 2013

(54) METHODS AND SYSTEMS FOR DETERMINING A RELATIVE IMPORTANCE OF A USER WITHIN A NETWORK ENVIRONMENT

(71) Applicant: RedDrummer LLC, New York, NY (US)

(72) Inventors: Andre Gustavo Vellozo Luz, New York, NY (US); Alberto Fernando Blumenschein Cruz, Sao Paulo (BR); Dalton Lopes Martins, Sao Paulo (BR)

(73) Assignee: RedDrummer LLC, New York, NY (US)

(21) Appl. No.: 13/924,026

(22) Filed: Jun. 21, 2013

Related U.S. Application Data
(60) Provisional application No. 61/663,383, filed on Jun. 22, 2012.

(51) Int. Cl. G06Q 30/02

(52) U.S. Cl. CPC G06Q 30/0201
USPC 705/7.29

(57) ABSTRACT

Methods and systems for determining a relative importance of a user within a network environment are disclosed. Interaction information pertaining to a plurality of interactions in an network environment may be received over a period of time. One or more relational actions may be identified among a plurality of users in the network environment based on the interaction information. A relative importance of at least one of the plurality of users in the network environment may be determined. A portion of a financial consideration may be assigned to each user based on the relative importance of the user.

### CROSS-REFERENCE TO RELATED APPLICATIONS

This application claims priority to U.S. provisional application Ser. No. 61/663,383, filed Jun. 22, 2012, which is incorporated herein by reference in its entirety.

### BACKGROUND

Typically, an entity or organization employs a plurality of individuals. Each individual performs a function within the organization associated with tasks that they are assigned and/or, in the case of managers, managing others that are assigned tasks. Each employee has a role in the success of the organization for which they work and are compensated according to their position and/or perceived benefit to the company based on their particular role.

However, determining whether an individual employee is appropriately compensated based on the tasks that the individual performs is difficult to ascertain. While an individual employee may be compared with or against the employee's peers, it is difficult to assign a precise value to the employee's benefit to the bottom line of the organization. As such, an employee may be undercompensated or overcompensated based on the value that the employee brings or has brought to the company.

Social networking provides a means of identifying and/or quantifying interactions between individuals and/or entities. Social networks enable individuals to connect with others that they know and/or with whom they have a common interest or occupation. As such, social networks can provide a framework identifying interpersonal relationships among individuals.

Data mining is a process by which relevant information is extracted from one or more databases. Data mining typically employs one or more filters that are used to limit the amount of data retrieved from the one or more databases to data that is relevant to a particular topic of interest. As such, data mining is an efficient way of extracting relevant information from a large compilation of data.

### SUMMARY

In an embodiment, a system for determining a relative importance of a user within a network environment may include a processing device and a non-transitory storage medium in operable communication with the processing device. The storage medium may contain one or more programming instructions that, when executed, cause the processing device to receive interaction information pertaining to a plurality of interactions in an network environment over a period of time, identify one or more relational actions between a plurality of users in the network environment based on the interaction information, for at least one user of the plurality of users, determine a relative importance of the user in the network environment, and assign a portion of a financial consideration to each user based on the relative importance of the user.

In an embodiment, a method of determining a relative importance of a user within a network environment may include receiving, by a processing device, interaction information pertaining to a plurality of interactions in an network environment over a period of time, identifying, by a processing device, one or more relational actions between a plurality of users in the network environment based on the interaction information, for at least one user of the plurality of users, determining, by a processing device, a relative importance of the user in the network environment, and assigning, by a processing device, a portion of a financial consideration to each user based on the relative importance of the user.

### BRIEF DESCRIPTION OF THE DRAWINGS

FIG. 1 depicts a block diagram of an illustrative system used to perform dynamic network analysis according to an embodiment.

FIG. 2 depicts a flow diagram of an illustrative method of determining a relative importance of a user within a network environment according to an embodiment.

FIG. 3 depicts a block diagram of illustrative internal hardware that may be used to contain or implement program instructions according to an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

Network interaction environments permit the identification of a plurality of factors that lead to the collective construction of ideas, processes and fluxes in “conversations” that often end in important innovations in work methods within an entity. Use of these factors, a plurality of different dimensions of evaluation, and cause and effect relationships represents a fundamental challenge in the exploration of the potential of network environments in determining the value of realized interactions and their impact on financial results realized by the entity within a period of time.

As such, the present disclosure identifies ways of considering, in an integrated form, relational actions related to interactions between users of an information system and the frequency of events realized within the possibilities offered by the system; forming temporal weightings which are distinguished from ordinary rates of interaction; and considering a semantic dimension that permits analysis of an amount of semantic variability produced by users and the method by which this degree of variability impacts the dynamic and structure of the networks being analyzed. The present disclosure identifies ways to enable entities to create parameters for the degree of importance of each of the dimensions being analyzed in a dynamic way. In addition, entities can define orders of priority based on the rate and work focus and identify how these vary in response to various events that occur on a daily or regular basis.

In addition, the present disclosure teaches methods for creating conditions for information systems to generate analytical panels based on the dimensions of the analysis that permit managers and users of the information systems to rapidly identify relevant trends in decision making processes based on historical comparisons.

Moreover, the integration of multiple dimensions of analysis may be used to construct indices to infer the value of the contribution of each user within the system to a financial result obtained or realized by an entity. These indices may be the result of a multi-variable calculation that may be used as a criterion in the distribution of financial results and/or gains.

Additionally, the teachings of the present disclosure may be applied in any information system that creates “relational” events between users to provide statistics and support calculations for the determination of the value of realized contributions. In addition, the teachings disclosed herein may support indices for the construction of control panels that enable the visualization of emerging effects in a network environment.

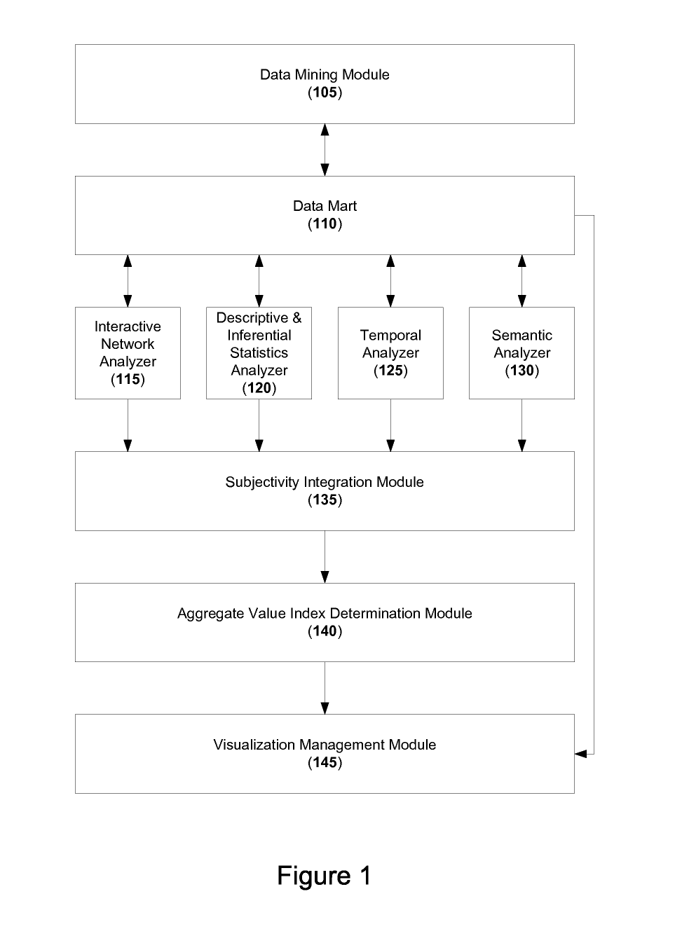

FIG. 1 depicts a block diagram of an illustrative system used to perform dynamic network analysis according to an embodiment. As shown in FIG. 1, the system 100 may include a data mining module 105, a data mart 110, an interactive network analyzer 115, a descriptive and inferential statistics analyzer 120, a temporal analyzer 125, a semantic analyzer 130, a subjectivity integration module 135, an aggregate value index determination module 140, and a visualization management module 145.

The data mining module 105 may be based on the “ETL” principle (“Extract, Transform and Load”) for the treatment of data and the creation of contextual and multidimensional data marts to reduce the cost of making a request to an application database and/or the amount of requests made to the application database. The data mining module 105 may prepare information within the dimensions necessary for processing by one or more of the analyzers 115-130.

The data mining module 105 may also receive a data filter to be used to classify information available in the data mart 110 considered for analysis. Exemplary semantic information filters may include unique words, idiomatic combinations and expressions, and specific time periods. In addition, determined interaction levels, such as work groups, communities, and entities, may also be considered as filters for the data mining module 105. Using such filters may guarantee that only data that falls within the established filtered criteria may be selected for inclusion in the data mart 110 for evaluation by the analyzers 115-130 as described in more detail below.

The filters of the data mining module 105 may be applied to a repository of a network environment, such as a database, to generate a data mart 110 that contains information meeting the filtered criteria. The data mart 110 may be used to generate data on direct relationships between people and between people and events. The structure of the data mart 110 may align with a common structure that can be modeled in a similar way in any information system to increase portability. In an embodiment, the data mart 110 may include a combination of relationships established between users in a plurality of “relational” events that the system 100 permits, the frequency of executed actions of each event in the system, and the combination of words used.

In various embodiments, the data mining module 105 may be configured to prepare information for a data mart 110 that is directed toward informal working groups of users and/or subjects inside a community that may not be ordinarily discovered via traditional methods of group discovery. This may generally be used to discover new useful group configurations, and may further provide a conversational ambience for the newly discovered groups to determine if new emerging concepts and explanations result from observing the culture of the community.

The data mart 110 may include a vector tool for words and expressions used by the users and/or subjects. The vector tool of the data mart 110 may identify the context in which each word and/or expression is used and an event and/or a time at which the word and/or expression was used. Using this information, the vector tool may be able to identify levels of semantic vulnerability of the users within their networks and specific contexts for the analysis.

In some embodiments, the vector tool of the data mart 110 may create a word vector space model from a set of published documents in a network, such as, for example, various users' posts, comments to posts, and/or the like, by indexing term frequency, where terms that have both high and low frequency within a document may be considered function words. The vector tool of the data mart 110 may use a stop list, which holds commonly used words (e.g., stop words) to exclude terms that are common and will not produce useful data. As a result, the indexing process may be completed faster by removing high frequency words in a document. In some embodiments, the vector tool of the data mart 110 may weight terms for a vector space model that is based on a statistical evaluation of single terms. In some embodiments, terms may be weighted based on various factors that define term weighting, such as, for example, term frequency factors, collection frequency factors, and length normalization factors.

The interactive network analyzer 115 may be used to index each user according to structural and dynamic characteristics within the multidimensional model included in the data mart 110. The structural and dynamic characteristics for the users may be indexed with respect to a user's relationship network. Structural positions may be determined based on the user's degree of centrality relative to other users within a network in accordance with the aggregate value index algorithm formula presented below.

The interactive network analyzer 115 may perform centrality calculations and generate historical information within the data mart 110. The centrality calculations may be defined, for example, as a number of ties that a user and/or a subject has with other users and/or subjects by posting content to the network or by commenting on content posted by other users and/or subjects. By performing these calculations and generating the historical information, the interactive network analyzer 115 may enable a user's evolution to be displayed and/or analyzed based on the user's structural position within the network over time. In addition, a first user's evolution may be compared with one or more second user's evolutions as a result of this analysis.

The descriptive and inferential statistics analyzer 120 may monitor and statistically describe one or more principal events that are generated by a user or with respect to a user within the interaction structures provided by an information system. The descriptive and inferential statistics analyzer 120 may process and archive the historical information generated by the interactive network analyzer 115 based on one or more time periods of interest to the user. In an embodiment, a mean frequency distribution, weighted deviation, and/or relative position of each user in relation to each interaction and/or interactive act may be used to provide base information. The base information can be used to provide context and intensity elements to one or more of the other analyzer modules (i.e., 115, 125 and 130). The information and data may be processed and may be used to generate historic series that are stored in the data mart 110.

The temporal analyzer 125, among other things, may identify one or more templates of user actions that represent anomalies in relation to the distributions that make up the actions and interactions monitored by the system 100. One Illustrative example of an anomaly may include interactional behavior that deviates from a typical known pattern of a specific community, such as, for example, users and/or subjects that comment or post indiscriminately and/or out of a regular temp, users and/or subjects whose networks are intensively connected (e.g., “clique” behavior) or non-connected (e.g., “open star” behavior), a strong interaction between a plurality of nodes, a specific node that is frequently connected by different users and/or subjects on different occasions, usage of non-typical word sequences, and/or the like. The temporal analyzer 125 may provide information to the data mart 110 when identifying templates so as to construct historic series data of contrasting and/or differentiating events. In addition, the temporal analyzer 125 may manage events that are used to identify tendencies and contrast occurrences in a network information panel interface.

The semantic analyzer 130 may identify the linguistic variability of one or more users. In addition, the semantic analyzer 130 may create a word and expression repository that is linked to the data mart 110. The semantic analyzer 130 identifies and indexes new expressions and/or words that are being used, expression and/or words that are no longer being used or are being used less frequently, new combinations of expressions and/or words, and the networks of users that are using (or are no longer using) the expressions and/or words that are listed above. Moreover, the semantic analyzer 130 may determine historic data and a semantic actuation index for each user and record the historic data and semantic actuation index in the data mart 110.

The subjectivity integration module 135 may enable users in the system or of the system to be assigned permission levels. The permission levels may be determined by project managers and/or administrators to define different weightings for each user. In this manner, events in the system that should be more influential in determining an aggregate value for a user may be prioritized for the user. Because the system 100 is intended to be managed by more than a single calculation formula, the system permits adaptations based on different production rates, conversion rates and interaction rates between users. As such, the system 100 may provide a greater level of subjectivity and a continuous adjustment or adjustability of this subjectivity within the parameterization of the system architecture.

The aggregate value index determination module 140 enables the integration of one or more of the analyzers and modules disclosed herein. The aggregate value index determination module 140 includes an aggregate value index algorithm that is used to provide a means of assimilating the information from the various modules into a more easily discernible determination mechanism. The aggregate value index algorithm may be used to parameterize the events that are considered as a basis for the calculation.

The aggregate value index algorithm may be constructed using the following defined parameters:

$${x}_{i} = α \times ( \sum ( \frac{{Cm}_{ij} \times {A}_{ij} \times {x}_{j}}{{k}_{j}^{out}} ) + β ) ,$$

where:

Aᵢⱼ is a relationship matrix between a node and all other nodes in the network;

xⱼ is a centrality of node j;

Cmᵢⱼ is an average or mean conclusiveness between i and j;

kⱼ^{out} represents a number of links pointing towards node j;

α=0.85; and

$$β = \frac{\begin{matrix}{p}_{1} \times CNER + {p}_{2} \times CNCR + {p}_{3} \times IR + {p}_{4} \times IRR + {p}_{5} \times \\ QIR + {p}_{6} \times N + {p}_{7} \times FT + {p}_{8} \times C + {p}_{9} \times ET + {p}_{10} \times VS\end{matrix}}{CNER + CNCE + IR + IRR + QIR + N + FT + C + ET + VS}$$

The mean conclusiveness provides a base that enables a user to evaluate what another user does within the system 100 and/or to the system. The mean conclusiveness depends on the evaluation criteria of each information system and is considered in the determination of centrality for a user. The mean conclusiveness represents an important contribution to the method by which the weighting is performed. In addition, the conclusiveness strengthens the system's 100 ability to provide meaningful information regarding how connections and/or relationships are perceived by users because it qualifies the connections and/or relationships on the basis of the effect that those connections and/or relationships have on the entity as a whole.

The Beta parameter (β) may be the weighted average of the frequencies of a plurality of events that are recorded in the system 100. The events are identified in Table 1 below.

TABLE 1
Factors for Beta (β)

| Indicator | Significance |
|---|---|
| CNER | Quantity of new content directed or pointing towards the |
| | network |
| CNCR | Quantity of new content created in the network |
| IR | Quantity of inferences made within the network |
| IRR | Quantity of reactive inferences that provoke a response to |
| | the above items within the network |
| QIR | Quality of related and/or relational inferences |
| N | Size of the network (i.e., number of users in the network) |
| FT | Frequency of recurrence of themes |
| C | Conclusiveness |
| ET | Temporal events of relevance |
| VS | Semantic variability |

The visualization management module 145 may enable a graphical user interface to be built for an information system. The visualization management module 145 may enable metrics and historical information to be easily accessible and accompanied and/or followed by the users. For example, the visualization management module 145 may be configured to be used by a user to manipulate data, reconfigure data, and/or obtain data in a form that is easily understandable by the user. In addition, the visualization management module 145 may permit the visualization of interaction networks for organizational levels and for semantic expressions that can be interactively searched and/or gathered by one or more users.

The systems and methods described herein may be implemented in a plurality of ways, such as, for example, an analytical module for a specific information system, a web service working with different web information sources, a mobile-based service that may act as a mobile extension to the web service, and a support module for business intelligence solutions offering the possibility of integration at different levels.

The evaluation techniques that are used in an integrated manner in the present disclosure are used to qualify and improve the relevance and reach of what are considered to be fundamental events, the modeling of the events and value creation within a network environment. The methods and systems disclosed herein may provide value in a plurality of different ways. The value may be stimulated by different interpretations and/or understandings of reality within which the system 100 is inserted. For example, value may be provided as a result of determined methods of interaction between people, where a structure is produced collectively and crossed by a plurality of relational events mapped within a network environment. A user may identify weightings associated with the user or other users from the modes of conversation between users, the type and variability of expressions used and the dynamic variability of the user's position within a network. These tendencies may be used to reflect different forms of understanding of value creation within a network.

In some embodiments, value may generally be determined by establishing a proportional participation of each user, subject, and/or group in a project development and rewarding each user, subject, and/or group proportionally to their observed interactions. The proportionality may be defined by how important particular posts and/or comments made by a particular user, subject, and/or group become to the project, where the importance may be determined by a calculation, by an administrator, or by one or more users, subjects, and/or groups collectively. In some embodiments, proportionality may be determined by how a particular group contributed to a new concept by interacting collectively around the project. In some embodiments, proportionality may be determined by how particular new terms and expressions contributed to conversations within the group.

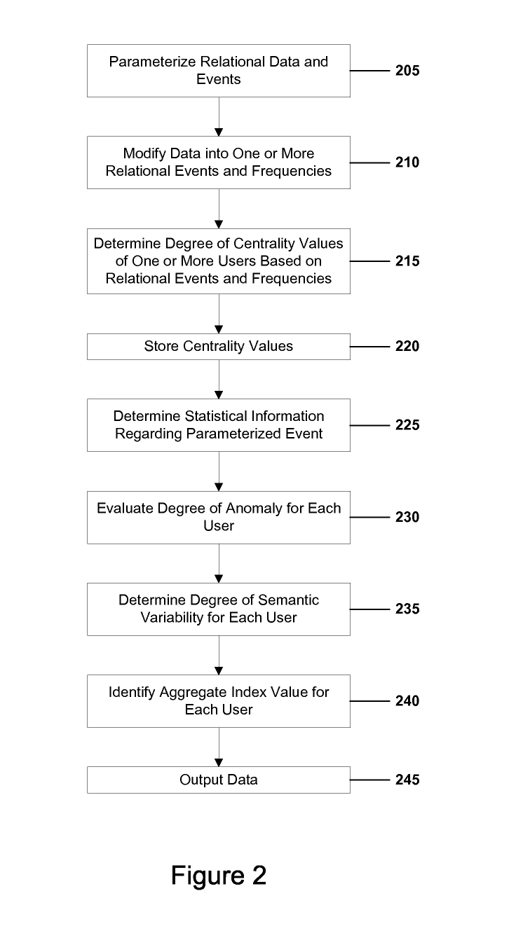

FIG. 2 depicts a flow diagram of an illustrative method of determining a relative importance of a user within a network environment according to an embodiment. As shown in FIG. 2, the data mining module may be parameterized 205 with relational data and events that are produced in an information system. The parameterization 205 may be a fundamental aspect of the creation of the data mart in that it synthesizes the fundamental analytic information and reduces the number of searches in the database of the application being analyzed. The parameterization 205 may be performed via a graphical user interface by application managers or via a program module that modifies configuration archives and structures.

The data mining module may extract data from a database based on the parameterization 205 and modify 210 the data into a form that is capable of being uploaded to the data mart. The information to be transformed 210 may include one or more relational events between users, one or more relational events between users and events, and the frequency of actions of each user in the relational events parameterized 205 by the information system. In addition, the time at which each relation event, event and/or relationship occurs may be recorded in the data mart. This may facilitate the identification of weights to be applied to the data by the application managers, program modules or other entities that analyze the data.

Once data has been uploaded to the data mart, the interactive network analyzer may consult relational data of users and relational data of users and events to determine 215 centrality values for each user. The centrality values may be determined 215 using the aggregate value index algorithm:

$${x}_{i} = α \times ( \sum ( \frac{{Cm}_{ij} \times {A}_{ij} \times {x}_{j}}{{k}_{j}^{out}} ) + β ) ,$$

which is described in further detail herein. It is noted that the average conclusiveness between the relationships of two users may be considered as one factor towards defining the weight that the relationship of the users is assigned. In an embodiment, conclusiveness may be used as a weighting factor in addition to a subjective evaluation factor between users and may be used to modify the perceived importance of the relationship between the users.

The centrality values for each user may be stored 220 in the data mart along with the time at which the determination 215 was made and the context in which the determination was made (i.e., what type of network is being analyzed based on the criteria that a user using the system selects and the user's motivation behind parameterization, if available). The centrality values may not be considered to be absolute because such values may vary depending on the information filter that determines the type of network that is being analyzed. For example, when using a particular information system, a user may use the analytics module to find the network of people that have discussions or conversations regarding a particular word or phrase. The module may select the users associated with the word or phrase from the data mart and create a new analysis network. The centrality of the users in the new analysis network may be determined 215 in a dynamic manner for the specific context. Once determined, the centrality for each user may be archived in historical information to ensure that the user may register the filter by which the network performed the analysis.

The descriptive and inferential statistics analyzer may be used to determine 225 statistical information regarding a parameterized event. In an embodiment, the descriptive and inferential statistics analyzer may determine 225 a mean distance for all users for a parameterized event. In an embodiment, the descriptive and inferential statistics analyzer may determine 225 a weighted distribution of distances for all users for a parameterized event. In an embodiment, the descriptive and inferential statistics analyzer may determine 225 a distance that a particular user is from the distribution of data for a parameterized event in the data mining module. The data used to perform the statistical analysis may be extracted from the information system. The determination 225 may be performed in a dynamic fashion and may depend on a search context that filters the data to be used in the analysis. The position of a user in the resulting statistical analysis may represent one element that is considered as a calculation parameter for the aggregate value index algorithm.

The temporal analyzer may evaluate 230 the degree of anomaly for each user within the distribution of related events and actions within the system or in relation to the group being analyzed. The temporal analyzer may identify one or more users that have corresponding intensities and movements within the network environment that differentiate the one or more users from other users that are selected by a determined filter. This degree of anomaly may be determined based on the average distance of each event in the system for each user in the system. The temporal analyzer may identify a temporal events of relevance variable that is used to balance and weight the aggregate value index for each user (see above).

This method of analyzing and identifying temporal variations for each user may be based on a specific network filter. In other words, the analyzing and identifying may enable the identification of emerging phenomena and/or differentiating temporal events through one of a plurality of layers of the network environment that may be created. The emerging phenomena and/or differentiating temporal events may be determined within the search context and lead to the analysis of the network layer that is created. It should be noted that the construction of personalized and relevant results indicating events and emerging network phenomena are relevant in the specific context for each network filter that permits authentic combinations of the information contained in the data mart. However, the information may not be as relevant in a general context.

The semantic analyzer may determine 235 a degree of semantic variability expressed by each user for each network being analyzed. The determination 235 may be made by calculating the distance of a word vector for each user from a vector that represents the average words used by all users in the network being analyzed. As used herein, the word vector may include a plurality of word/number pairs, where each number identifies a frequency with which the word is used. Additional information may be stored in the word vector as well. In addition, the information identified above for a word vector may be recorded in an alternate way. The word vector for a user may thus represent a frequency with which a user uses the words that the user uses. Similarly, the average word vector may represent a word vector that contains information regarding the words used by the users in the network as a whole. The information may include the average frequency of word usage for each word, the frequency of word usage for an average user (i.e., the mode) for each word and/or any other similar statistical measurement for word usage. By determining the degree of semantic variability for each user based on the word vectors, the variability constructed and assigned to articulation as a contribution to the participation of each individual user in the network may be determined. The semantic analyzer controls the semantic variability variable of the aggregate value index algorithm described above.

The subjectivity integration module may be a parameterization module that defines the weighting of each variable used in the Beta (β) parameter of the aggregate value index algorithm. The subjectivity integration module may be accessed via the information system and may pass one the value of each parameter to determine its weight for the calculation of the aggregate value index. The algorithm may receive the weighted values via the subjectivity integration module and add them to the degree of centrality determined 215 by the interactive network analyzer. The subjectivity integration module may perform 240 the integration of the calculation and generate a vector that identifies each user and the user's aggregate index value. The data may then be processed by an information system. The information system may determine a value that is distributed to each user based on, for example and without limitation, the financial results of an entity.

The visualization management module may receive trend data processed by the structure of each of the analyzers and manage a synthesis of the information from the analyzers that can be aggregated in a graphical user interface or user control panel. In addition, the visualization management module may provide 245 data to an administrator or user in an organized manner to allow the administrator or user to manage visualization of images of social networks. As such, the administrator or user may be provided 245 with knowledge pertaining to the evolution of connections of the users and enable articulation of the positioning of the users within the network environment.

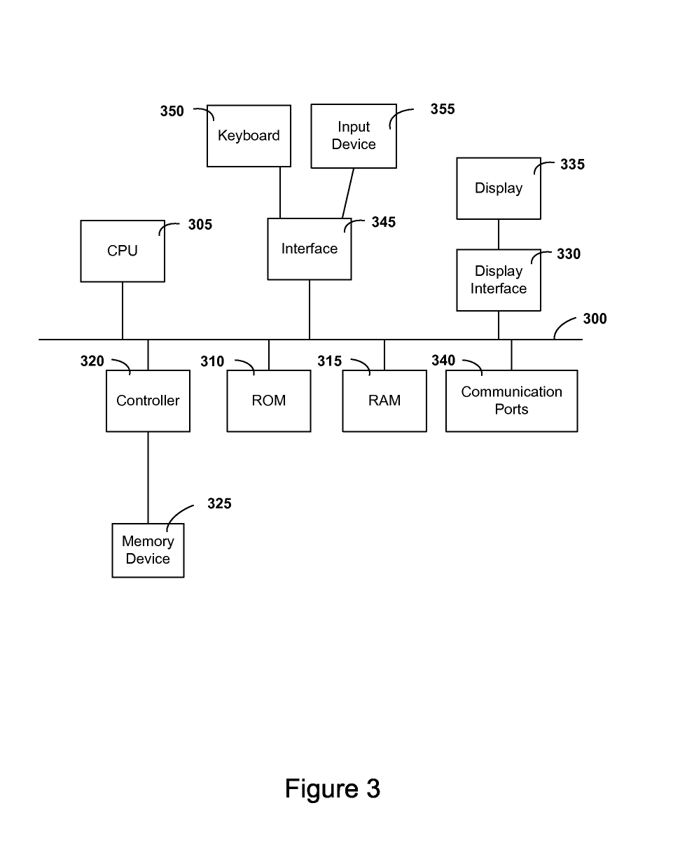

FIG. 3 depicts a block diagram of illustrative internal hardware that may be used to contain or implement program instructions, such as the process steps discussed herein in reference to FIG. 2, according to an embodiment. A bus 300 serves as the main information highway interconnecting the other illustrated components of the hardware. CPU 305 is the central processing unit of the system, performing calculations and logic operations required to execute a program. CPU 305, alone or in conjunction with one or more of the other elements disclosed in FIG. 3, is an illustrative processing device, computing device or processor as such terms are used within this disclosure. Read only memory (ROM) 310 and random access memory (RAM) 315 constitute illustrative memory devices (i.e., processor-readable non-transitory storage media).

A controller 320 interfaces with one or more optional memory devices 325 to the system bus 300. These memory devices 325 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 310 and/or the RAM 315. Optionally, the program instructions may be stored on a tangible computer readable medium such as a compact disk, a digital disk, flash memory, a memory card, a USB drive, an optical disc storage medium, such as a Blu-ray™ disc, and/or other non-transitory storage media.

An optional display interface 330 may permit information from the bus 300 to be displayed on the display 335 in audio, visual, graphic or alphanumeric format. Communication with external devices, such as a print device, may occur using various communication ports 340. An illustrative communication port 340 may be attached to a communications network, such as the Internet or an intranet.

The hardware may also include an interface 345 which allows for receipt of data from input devices such as a keyboard 350 or other input device 355 such as a mouse, a joystick, a touch screen, a remote control, a pointing device, a video input device and/or an audio input device.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A system for determining a relative importance of a user within a network environment, the system comprising:
a processing device,
a non-transitory, processor-readable storage medium in operable communication with the processing device, wherein the storage medium contains one or more programming instructions that, when executed, cause the processing device to:
receive interaction information pertaining to a plurality of interactions in a network environment over a period of time,
identify one or more relational actions between a plurality of users in the network environment based on the interaction information,
for at least one user of the plurality of users, determine a relative importance of the user in the network environment, and
assign a portion of a financial consideration to each user based on the relative importance of the user.

2. The system of claim 1, wherein the storage medium further contains one or more programming instructions that, when executed, cause the processing device to:
receive event information from a plurality of sources, wherein the event information pertains to an event that occurred within the network environment; and
store the event information in a database.

3. The system of claim 2, wherein the one or more programming instructions that, when executed, cause the processing device to receive interaction information comprise one or more programming instructions that, when executed, cause the processing device to receive the interaction information from the database.

4. The system of claim 2, wherein the event information comprises one or more of the following:
a time at which the event occurred;
one or more related events; and
a relationship between the event and each of the one or more related events.

5. The system of claim 1, wherein the interaction information comprises one or more of the following:
a relational event between a plurality of users;
a relational event between one or more users and one or more events; and
a frequency of actions of a user for each of a plurality of relational events.

6. The system of claim 1, wherein the one or more programming instructions that, when executed, cause the processing device to determine a relative importance of the user comprise one or more programming instructions that, when executed, cause the processing device to determine the relative importance of the user based on one or more of the following:
a quantity of new content directed towards the network environment;
a quantity of new content created in the network environment;
a quantity of inferences made within the network environment;
a quantity of relational inferences that provoke a response to the content directed towards the network environment, the content created in the network environment, and the inferences made within the network environment;
a measure of quality of the inferences made within the network environment;
a number of users in the network environment; and
a frequency of recurrence of one or more themes related to the user in the network environment.

7. The system of claim 1, wherein the one or more programming instructions that, when executed, cause the processing device to determine a relative importance of the user comprise one or more programming instructions that, when executed, cause the processing device to determine the relative importance of the user based on the following equation:
$${x}_{i} = α \times ( {\sum }_{j} ( \frac{{Cm}_{ij} \times {A}_{ij} \times {x}_{j}}{{k}_{j}^{out}} ) + β ) ,$$
wherein:
α is a constant, Cmᵢⱼ is an average conclusiveness between users i and j, A is a relationship matrix between users in the network environment, Aᵢⱼ is a relationship between users i and j, xⱼ is a measure of the relative importance of user j, kⱼ^{out} is a number of links pointing towards user j, and β is a weighted average of one or more values pertaining to events in the network environment.

8. The system of claim 1, wherein the one or more programming instructions that, when executed, cause the processing device to determine a relative importance of the user comprise one or more programming instructions that, when executed, cause the processing device to:
generate a word vector for a user, wherein the word vector comprises a vector of words used by a user in the network environment and a frequency associated with each word;
generate an average word vector for the plurality of users in a network environment, wherein the average word vector comprises a vector of words used by the plurality of users in the network environment and a frequency associated with each word; and
determine a distance between the word vector for the user and the average word vector.

9. The system of claim 1, wherein the one or more programming instructions that, when executed, cause the processing device to assign a portion of the financial consideration to each user comprises one or more programming instructions that, when executed, cause the processing device to partition financial gains realized by an entity during the period of time.

10. A method of determining a relative importance of a user within a network environment, the method comprising:
receiving, by a processing device, interaction information pertaining to a plurality of interactions in a network environment over a period of time;
identifying, by a processing device, one or more relational actions between a plurality of users in the network environment based on the interaction information;
for at least one user of the plurality of users, determining, by a processing device, a relative importance of the user in the network environment; and
assigning, by a processing device, a portion of a financial consideration to each user based on the relative importance of the user.

11. The method of claim 10, further comprising:
receiving event information from a plurality of sources, wherein the event information pertains to an event that occurred within the network environment; and
storing the event information in a database.

12. The method of claim 11, wherein receiving interaction information comprises receiving the interaction information from the database.

13. The method of claim 11, wherein the event information comprises one or more of the following:
a time at which the event occurred;
one or more related events; and
a relationship between the event and each of the one or more related events.

14. The method of claim 10, wherein the interaction information comprises one or more of the following:
a relational event between a plurality of users;
a relational event between one or more users and one or more events; and
a frequency of actions of a user for each of a plurality of relational events.

15. The method of claim 10, wherein determining a relative importance of the user comprises determining the relative importance of the user based on one or more of the following:
a quantity of new content directed towards the network environment;
a quantity of new content created in the network environment;
a quantity of inferences made within the network environment;
a quantity of relational inferences that provoke a response to the content directed towards the network environment, the content created in the network environment, and the inferences made within the network environment;
a measure of quality of the inferences made within the network environment;
a number of users in the network environment; and
a frequency of recurrence of one or more themes related to the user in the network environment.

16. The method of claim 10, wherein determining a relative importance of the user comprises determining the relative importance of the user based on the following equation:
$${x}_{i} = α \times ( {\sum }_{j} ( \frac{{Cm}_{ij} \times {A}_{ij} \times {x}_{j}}{{k}_{j}^{out}} ) + β ) ,$$
wherein:
α is a constant, Cmᵢⱼ is an average conclusiveness between users i and j, A is a relationship matrix between users in the network environment, Aᵢⱼ is a relationship between users and j, xⱼ is a measure of the relative importance of user j, kⱼ^{out} is a number of links pointing towards user j, and β is a weighted average of one or more values pertaining to events in the network environment.

17. The method of claim 10, wherein determining a relative importance of the user comprises:
generating a word vector for a user, wherein the word vector comprises a vector of words used by a user in the network environment and a frequency associated with each word;
generating an average word vector for the plurality of users in a network environment, wherein the average word vector comprises a vector of words used by the plurality of users in the network environment and a frequency associated with each word; and
determining a distance between the word vector for the user and the average word vector.

18. The method of claim 10, wherein assigning a portion of financial consideration to each user comprises partitioning financial gains realized by an entity during the period of time.
